(19) United States
(12) Patent Application Publication
(10) Pub. No.: US 2025/0067563 A1
(43) Pub. Date: Feb. 27, 2025

(54) Methods and Apparatus to Select and Present Level-Change Way Points for Indoor Navigation Systems

(71) Applicant: GOOGLE LLC, Mountain View, CA (US)

(72) Inventors: Daniel J. Filip, San Jose, CA (US); Seung Woo Shin, San Jose, CA (US); Eric Lai-Ong, San Jose, CA (US); Steve Toh, San Jose, CA (US)

(21) Appl. No.: 18/725,119

(22) PCT Filed: Dec. 27, 2021
(86) PCT No.: PCT/US2021/065216

§ 371 Date: Jun. 27, 2024

(51) Int. Cl. G01C 21/20; G06F 3/01

(52) U.S. Cl. CPC G01C 21/206; G06F 3/011

(57) ABSTRACT

Methods and apparatus to select and present level-change way points for indoor navigation systems are disclosed. An example method includes: receiving, from a client device having a navigation system interface, a request for navigation directions from a starting point to a destination point; identifying, by one or more processors, a plurality of level-change way points based on a starting level associated with the starting point; determining, by one or more processors, a subset of two or more of the plurality of level-change way points based on a destination level associated with the destination point; selecting, by one or more processors, a selected level-change way point from the subset based upon one or more criteria; and providing, to the client device, directions to present an indication of a location of the selected level-change way point in the navigation system user interface.

### FIELD OF TECHNOLOGY

The present disclosure relates to indoor navigation systems and, more particularly, to methods and apparatus to select and present level-change way points for indoor navigation systems.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Navigation systems have proven useful for indoor and outdoor navigation. In the navigation context, for example, augmented reality (AR) can be used to overlay real-time camera images/video with annotations of points of interest. Such systems may provide, via a navigation system interface, turn-by-turn step directions and/or indications of where their destination is located. Indoor spaces may require changing levels such as those between floors or levels of a building. These level-changes are typically done via level-change way points. Example level-change way points include stairs, escalators, elevators, lifts, and ramps. Accordingly, in order to provide indoor navigation information, it may be necessary to expand route selection to comprehend levels and level-change way points, and to indicate level-change way points in a navigation system interface.

### SUMMARY

In some implementations described herein, algorithms select a recommended level-change way point from a plurality of possible level-change way points based upon one or more criteria, and cause a navigation system interface to present an indication of a location of the recommended level-change way point for a user.

In an example implementation, a method for selecting and presenting level-change way points for indoor navigation systems includes: receiving, from a client device having a navigation system interface, a request for navigation directions from a starting point to a destination point; identifying, by one or more processors, a plurality of level-change way points based on a starting level associated with the starting point; determining, by one or more processors, a subset of two or more of the plurality of level-change way points based on a destination level associated with the destination point; selecting, by one or more processors, a selected level-change way point from the subset based upon one or more criteria; and providing, to the client device, directions to present an indication of a location of the selected level-change way point in the navigation system user interface.

In another example implementation, a computing device is configured to implement the method of the above example implementation.

In still another example implementation, one or more non-transitory, machine-readable media store instructions that, when executed by one or more processors, cause the one or more processors to implement the method of the above example implementation.

### BRIEF DESCRIPTION OF THE DRAWINGS

The accompanying figures, where like reference numerals refer to identical or functionally similar elements throughout the separate views, together with the detailed description below, are incorporated in and form part of the disclosure, and serve to further illustrate implementation of concepts that include the claimed invention, and explain various principles and advantages of those implementations.

FIG. 1 is a block diagram of an example system in which techniques for selecting and presenting recommended level-change way points may be implemented, according to an implementation.

FIGS. 2A-2H depict example navigation system interfaces that may be presented by the client device of FIG. 1.

FIG. 3 is a flow diagram of an example method that may be implemented by the server and/or the client device of FIG. 1 for selecting a level-change way point for recommendation, according to an implementation.

FIG. 4 is a block diagram of an example level-change way point selector that may be used by the map/navigation application 132 and/or the map/navigation engine 146 of FIG. 1 for recommending level-change way points, according to an implementation.

FIG. 5 is a flow diagram of another example method that may be implemented by the server and/or the client device of FIG. 1 for selecting a level-change way point for recommendation, according to an implementation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In conventional navigation systems, the nearest level-change way point to a starting point is selected and indicated in a navigation system interface. However, the nearest level-change way point may not represent a user's preferences, may not provide needed accessibility accommodations, may not represent the most commonly selected way point, may not provide the quickest navigation to a destination point, may be a congested way point, may be associated with certain security requirements, etc. Moreover, in tall buildings with, for example, many different elevator banks that serve only certain floors, the nearest level-change way point may be incapable of reaching a destination floor associated with a destination point. Thus, in at least these instances, simply choosing the nearest level-change way point to a starting point may not yield a best or optimal route.

Methods and apparatus to select and present level-change way points for indoor navigation systems are disclosed. In some examples, a system identifies the level-change way points that are accessible from or service a starting level associated with a starting point. For example, the system may identify level-change way points that have a point of access on the starting level. Example points of access include a landing of a staircase or escalator, and an elevator door. However, some of the identified level-change way points may not, directly or indirectly, provide access to or service a destination level associated with a destination point. A level-change way point may provide indirect access by providing direct access to an intermediate level, where an additional level-change way point provides direct or indirect access to the destination level from the intermediate level. The system determines a subset of the identified level-change way points that directly or indirectly provide access to or service the destination level. The system then applies one or more criteria to select one of the subset of the identified level-change way points as a recommended or suggested level-change way point. The system provides directions to a client device to present the recommended or suggested level-change way point and/or navigation directions thereto in a user's navigation system interface of the client device.

In some examples, a navigation system interface of a client device uses and presents information regarding a recommended or suggested level-change way point as a user navigates an indoor space. In some examples, an indication is presented in the navigation system interface to indicate in which direction a user should/may turn in order to see the recommended level-change way point in their navigation system interface, and/or to access the recommended level-change way point. In an example augmented reality (AR) view, the recommended or suggested level-change way point, or an indication thereof, is displayed on the client device alongside an image or video of an indoor space. Additionally and/or alternatively, the level-change way point may be shown in a two-dimensional (2D) map if the user is in that mode rather than in an AR view. In some examples, only the recommended or suggested level-change way point is identified to reduce clutter in a user' navigation system interface.

Example criteria for selecting a level-change way point include a requirement or preference for an elevator, a preference for escalators over elevators or stairs, a requirement or preference for no stairs, a need for wheel chair accessibility, which level-change way points have been used most popular, and which level-change way points provide a fastest route. In some examples, the user provides, selects or otherwise inputs criteria by, for example, accessing a settings user interface of a navigation system interface. Additionally and/or alternatively, a system for selecting and presenting level-change way points for indoor navigation systems learns or adapts criteria based upon past usage of level-change way points. For example, by recording usage data relating to how users actually traversed between levels of an indoor space is utilized when selecting future recommended level-change way points. Example usage data includes which level-change way points are used most often, which level-change way points are used despite a recommendation of a different level-change way point, and times associated with navigating via various level-change way points.

In some examples, a machine learning algorithm is trained and used to select recommended or suggested level-change way points. The machine learning algorithm can learn or adapt over time in response to actual level-change way point usage data. Example usage data includes user preferences, which level-change way points have been most used by other users, and the amount of time it takes to change levels via each of the subset of level-change way points. In some examples, a plurality of machine learning algorithms are trained and used to recommend level-change way points for respective ones of a plurality of indoor spaces. Example indoor spaces include transportation systems, transportation hubs, shopping centers, office buildings, and residential buildings.

These and other disclosed examples improve the technical task of providing navigation assistance for indoor spaces. More particularly, disclosed examples help users to more quickly and easily navigate between levels of indoor spaces. By selecting recommended level-change way points based on their access to particular levels, and one or more criteria rather than just proximity, disclosed examples improve the technical task of providing indoor navigation directions. Moreover, in some examples, usage data relating to how users actually traversed between levels of an indoor space is utilized when selecting future recommended level-change way points. In this way, recommendations regarding level-change way points will be more and more likely overtime to be taken by users. By thus providing better recommendations over time, disclosed examples improve route recommendations over time regarding navigation directions provided for indoor spaces.

Reference will now be made in detail to non-limiting implementations, some of which are illustrated in the accompanying drawings.

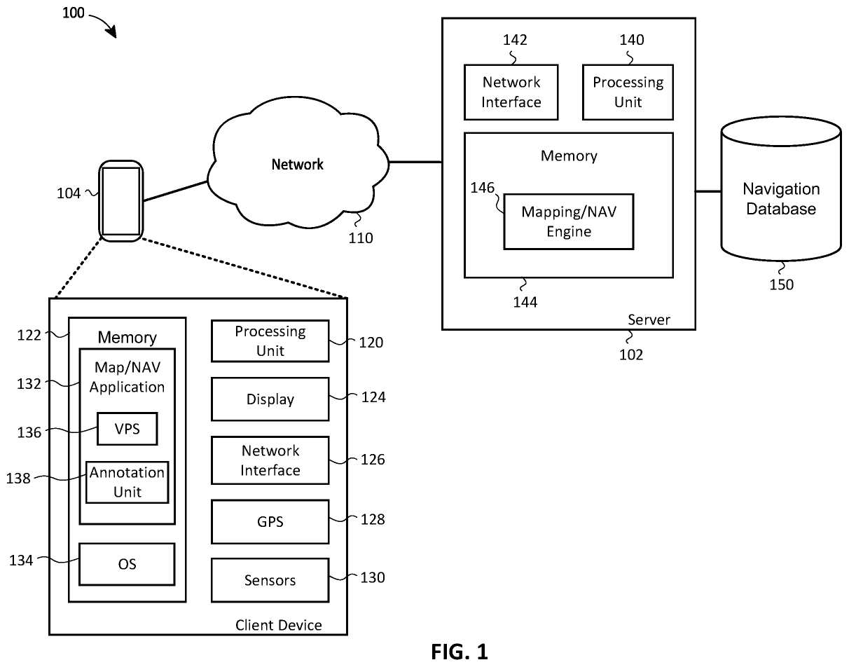

FIG. 1 illustrates an example system 100 in which one or more techniques for facilitating indoor navigation may be implemented. The system 100 includes an example server 102, an example client device 104 of a user, and a network 110. The server 102, which provides mapping and possibly other (e.g., navigation) services, is remote from the client device 104, and is communicatively coupled to the client device 104 via the network 110. The network 110 may be a single, wireless communication network (e.g., a cellular network), and in some implementations also includes one or more additional networks. As just one specific example, the network 110 may include a cellular network, the Internet, and a server-side local area network. While FIG. 1 shows only the client device 104, it is understood that the server 102 may also be in communication with numerous other client devices similar to the client device 104. Moreover, while referred to herein as a server, the server 102 may, in some implementations, include multiple co-located or remotely distributed computing devices.

While shown in FIG. 1 as having a smartphone form factor, the client device 104 may be any mobile or portable computing device with wireless communication capability (e.g., a smartphone, a tablet computer, a laptop computer, a wearable device such as smart glasses or a smart watch, a vehicle head unit computer, etc.). In the implementation of FIG. 1, the client device 104 includes a processing unit 120, memory 122, a display 124, a network interface 126, a GPS unit 128, and a number of sensors 130. The processing unit 120 may be a single processor (e.g., a central processing unit (CPU)), or may include a set of processors (e.g., multiple CPUs, or one or more CPUs and one or more graphics processing units (GPUs)).

The memory 122 includes one or more machine-readable, non-transitory storage units or devices, which may include persistent (e.g., read-only memory, a hard disk, solid-state memory, and flash memory) and/or non-persistent (e.g., random-access memory) storage components. The memory 122 stores instructions that are executable on the processing unit 120 to perform various operations, including the instructions of various software applications, and the data generated and/or used by such applications. In the implementation of FIG. 1, the memory 122 stores at least a map/navigation (NAV) application 132 and an operating system (OS) 134.

Generally, the map/navigation application 132 (and any positioning application) is executed by the processing unit 120 to access the mapping and navigation services (and positioning services, if available) provided by the server 102, and to present navigation information in a navigation system interface. The map/navigation application 132 includes a visual positioning system (VPS) 136 and an annotation unit 138. In general, the VPS 136 associates portions of the user's current real-world view (as captured by one or more cameras of the sensors 130, discussed below) with portions of a 3D model of the environment (also discussed below), while the annotation unit 138 determines when and how to annotate mapped elements and/or level-change way points that the VPS 136 has already associated with portions of the user's current real-world view. It is understood that, in various implementations, the functionality of each of the VPS 136 and/or the annotation unit 138 may instead be provided by multiple cooperating units or modules, and/or the functionality of both the VPS 136 and the annotation unit 138 may be provided by a single software unit or module, etc.

While the description below refers to a map/navigation application 132, it is understood that, in other implementations, other arrangements may be used to access the services provided by the server 102. For example, the client device 104 may instead access some or all of the map/navigation services via a web browser provided by a web browser application stored in the memory 122. In some alternative implementations, the map/navigation application 132 is only used to access mapping services without navigation services (e.g., without providing step by step instructions for reaching a desired destination).

The display 124 includes hardware, firmware, and/or software configured to enable a user to view visual outputs of the client device 104, and may use any suitable display technology (e.g., LED, OLED, LCD, etc.). In some implementations, the display 124 is incorporated in a touchscreen having both display and manual input capabilities. Moreover, in some implementations where the client device 104 is a wearable device, the display 124 is a transparent viewing component (e.g., one or both lenses of smart glasses) with integrated electronic components. For example, the display 124 may include micro-LED or OLED electronics embedded in one or both lenses of smart glasses.

The network interface 126 includes hardware, firmware, and/or software configured to enable the client device 104 to wirelessly exchange electronic data with the server 102 via the network 110. For example, the network interface 126 may include a cellular communication transceiver, a WiFi transceiver, and/or transceivers for one or more other wireless communication technologies.

The GPS unit 128 includes hardware, firmware, and/or software configured to enable the client device 104 to self-locate using GPS technology (alone, or in combination with the services of server 102 and/or another server not shown in FIG. 1). Alternatively and/or additionally, the client device 104 may include a unit configured to self-locate, or configured to cooperate with a remote server or other device(s) to self-locate, using other non-GPS technologies. For example, the client device 104 may include a unit configured to self-locate using WiFi positioning technology. For example, the client device 140 may send signal strengths detected from nearby access points to the server 102 along with identifiers of the access points, or to another server configured to retrieve access point locations from a database and calculate the position of the client device 104 using trilateration or other techniques.

The sensors 130 include one or more cameras (e.g., charge-coupled device (CCD) cameras, or cameras using any other suitable technology) positioned so as to capture a real-time field of view in front of a user as he or she walks (or otherwise moves) about or changes direction. In implementations where the client device 104 is a smartphone, for example, the camera(s) and the display 124 may face in opposite directions, to allow the user to view the environment in front of him/her as he/she holds the smartphone generally up and with the display 124 facing his or her face. As another example, in implementations where the client device 104 is a pair of smart glasses, the camera(s) may be embedded in the frame of the smart glasses, adjacent to one or both lenses of the smart glasses and directed away from the wearer's/user's face. The sensors 130 may also include one or more sensors configured to determine a real-time orientation of the client device 104 within the physical world. For example, the sensors 130 may include an inertial measurement unit (IMU) (e.g., one or more accelerometers, gyroscopes, etc.) configured to generate data indicative of movement of the client device 104 in three dimensions, including rotational movement around any one of the three axes of rotation.

The OS 134 can be any type of suitable mobile or general-purpose operating system. The OS 134 may include application programming interface (API) functions that allow applications to access information from other components of the client device 104. For example, the map/navigation application 132 may include instructions that invoke an API of the OS 134 to retrieve a current location of the client device 104 (e.g., as determined by the GPS unit 128) and an orientation of the client device 104 (e.g., as determined by one or more of the sensors 130), at particular instances in time.

While FIG. 1 shows a single client device 104 communicating directly (i.e., via network 110) with the server 102, in some implementations the components of the client device 104 shown in FIG. 1 are instead divided among two or more user-side devices. For example, a pair of smart glasses may include the processing unit 120, the memory 122, the display 124, and the sensors 130, while a smartphone may include another processing unit and memory, another display, the network interface 126, and the GPS unit 128. The smart glasses (or smart helmet, etc.) may then communicate as needed with the smartphone (e.g., via Bluetooth) to enable the operations described herein.

The server 102 includes a processing unit 140, a network interface 142, and memory 144. The processing unit 140 may be a single processor, or may include two or more processors. The network interface 142 includes hardware, firmware, and/or software configured to enable the server 102 to exchange electronic data with the client device 104 and other similar client devices via the network 110. For example, the network interface 142 may include a wired or wireless router and a modem.

The memory 144 is a machine-readable, non-transitory storage unit or device, or collection of units/devices that may include persistent and/or non-persistent memory components. The memory 144 stores instructions of a map/navigation engine 146, which may be executed by the processing unit 140. The mapping and navigation components of the map/navigation engine 146, or portions thereof (e.g., a routing engine for determining optimal or otherwise recommended level-change way points based on a starting point and a destination point) may be provided by separate engines. In some alternative implementations, the memory 144 does not store instructions of a navigation engine (e.g., such that the server 102 is only a mapping server that cannot provide navigation services).

In the implementation shown, the map/navigation engine 146 is generally configured to provide client devices, such as the client device 104, with mapping and navigation services that are accessible via a navigation system interface provided by client device applications, such as the map/navigation application 132. For example, the map/navigation engine 146 may receive via the network 110 a navigation request that was entered by the user of the client device 104 via the map/navigation application 132, and forward a starting point and a destination point specified by (or otherwise associated with) the navigation request to the map/navigation engine 146. The map/navigation engine 146 may determine a best route, or set of routes, including a recommended or suggested level-change way point if applicable, from the starting point to the destination point, and retrieve map information corresponding to an indoor area that includes the determined route(s) and/or level-change way point. The server 102 may retrieve navigation information for an indoor space from a database 150, which includes information regarding mapped elements (e.g., walkways, hallways, doors, level-change way points, stores, rooms, etc.) of the indoor space.

Preferably, the navigation information contained in the database 150 includes a high-precision, three-dimensional (3D) model of an indoor space, rather than (or in addition to) a 2D model. The 3D model includes not only 2D positional information (e.g., latitude and longitude) but also level information for the mapped elements.

The map/navigation engine 146 may cause the network interface 142 to transmit the relevant 3D map information retrieved from the database 150, along with any navigation data generated by the map/navigation engine 146 (e.g., turn-by-turn text instructions, a recommended level-change way point, etc.) to the client device 104 via the network 110. The database 150 may consist of just one database or comprise multiple databases, and may be stored in one or more memories (e.g., the memory 144 and/or another memory) at one or more locations. In some implementations, multiple different databases 150 are implemented for respective ones of multiple different indoor spaces.

In at least one mode of operation, the map/navigation application 132 can provide a dynamic, first-person perspective, AR view of the user's real-world environment such as an indoor space, substantially in real-time as the user moves the client device 104 through (and/or rotates or otherwise reorients the client device 104 within) that environment. To provide the real-world portion of the first-person perspective view, the map/navigation application 132 presents (e.g., via the display 124) a real-time view of the user's environment comprising sequential (video) images/frames captured by the camera(s) 130. Alternatively (e.g., if the client device 104 is a pair of smart glasses), the real-time view can be the portion of the real world that the user directly observes through one or more lenses, with the camera(s) of the sensors 130 and the lens(es) of the device 104 being configured such that the camera field of view at least approximates the user's field of view at any given time.

In order to overlay or otherwise augment that real-time view with appropriate map information, the VPS 136 continuously or periodically performs geo-localization. In particular, the VPS 136 repeatedly (e.g., periodically) determines the current location of the client device 104, as well as the current orientation of the client device 104, within the physical world, and determines which portions of the 3D model of the environment correspond to that location and orientation (field of view). The VPS 136 may determine the device position/location using the GPS unit 128 (e.g., by using an application programming interface (API) of the OS 134 to obtain from the GPS unit 128 the latitude, longitude, and altitude of the client device 104), or another self-localization component of the client device 104, and may determine the device orientation using an IMU of the sensors 130 (e.g., by using an API of the OS 134 to obtain from the IMU absolute or differential orientation information). The VPS 136 uses this position and orientation information to determine which portions of the 3D model of the environment are currently within the user's field of view, either by accessing the 3D model via the server 102, or by accessing a local portion of the 3D model that was previously downloaded (e.g., pre-fetched), depending on the implementation and/or scenario. In some implementations, the VPS 136 also uses camera images (obtained by one or more cameras of the sensors 130) to correlate the real-world view to elements of the 3D model, e.g., by matching 2D planes detected in the camera images to 2D planes in the 3D model.

The VPS 136 uses the information generated by the IMU to determine the direction (in azimuth and elevation) in which the client device 104 is currently facing, and then determines which portion of the 3D model corresponds to objects (e.g., stores, level-change way points, etc.) that can be seen in that direction. In some implementations, for purposes of view augmentation, the VPS 136 only determines which portion of the 3D model of the environment corresponds to objects that are within a threshold distance of the device 104.

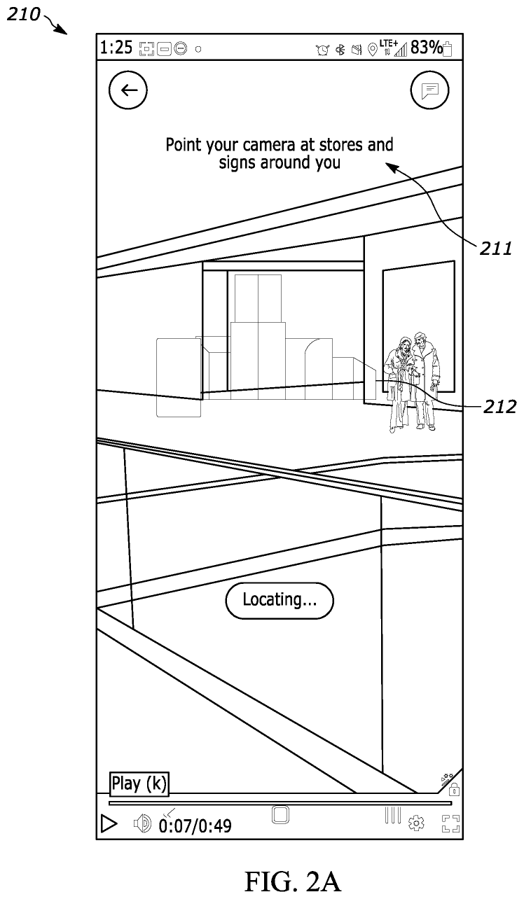

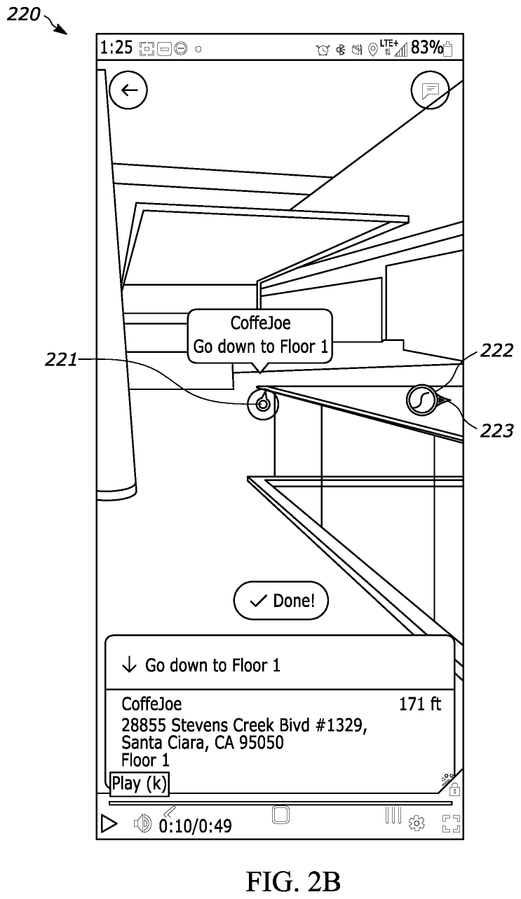

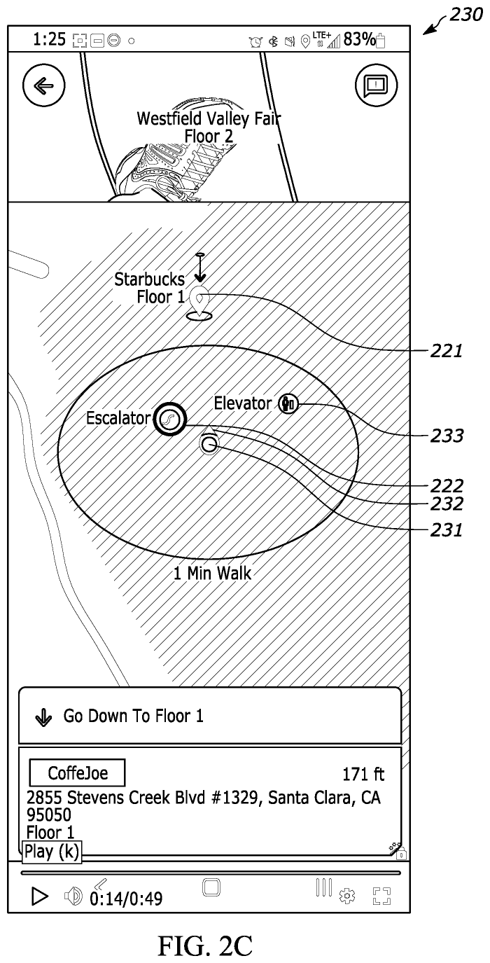

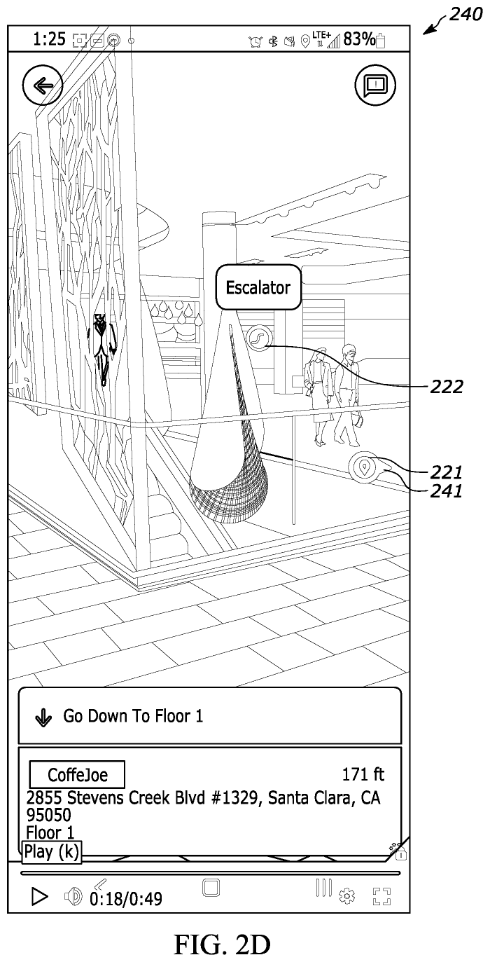

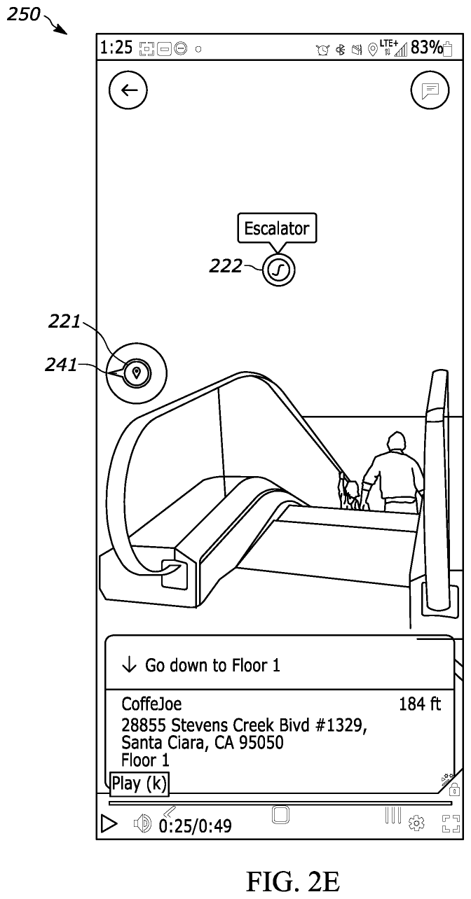

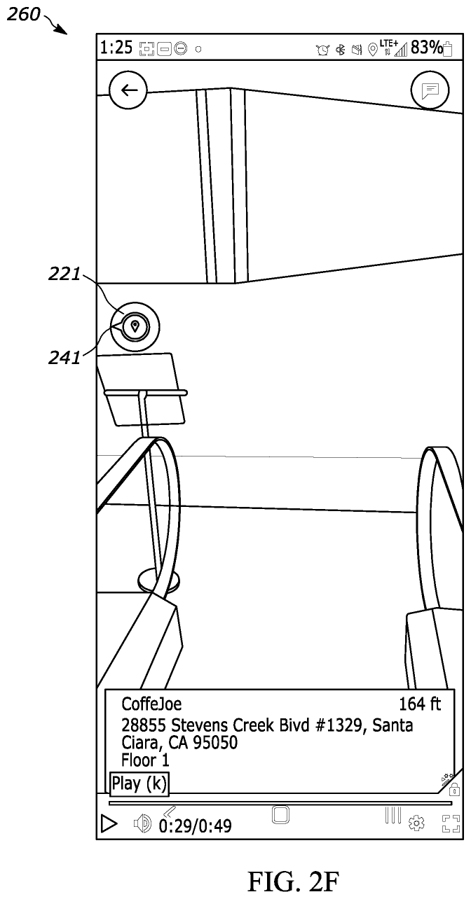

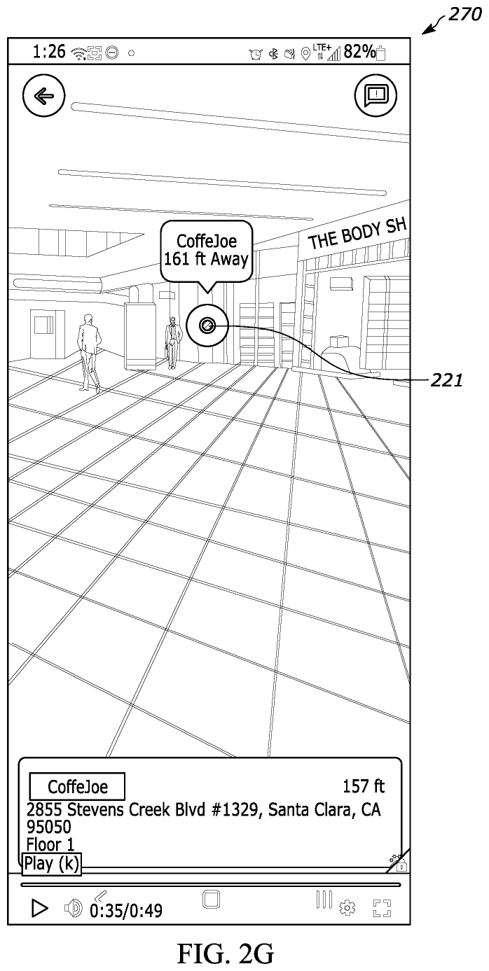

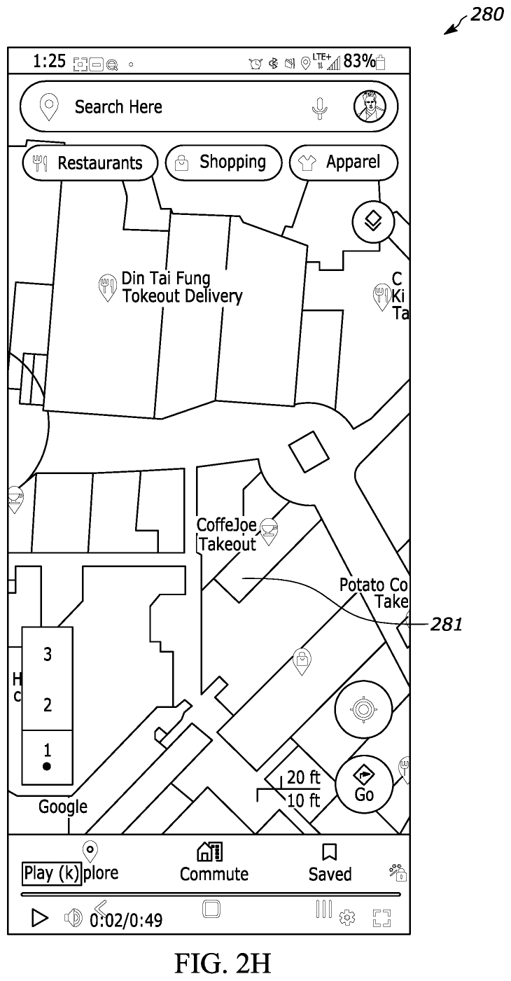

FIG. 2A depicts an example navigation system interface 210 that may be presented by the map/navigation application 132 of the client device 104 showing a real-world 3D view of a portion of an indoor space in the form of an indoor shopping center. The navigation system interface 210 provides example instructions 211 that direct a user to point their camera at stores and signs. The VPS 136 can compare images captured by the camera with portions/elements 212 of a 3D model to identify the portion of the indoor space being imaged by the camera and, thus, the direction (in azimuth and elevation) in which the client device 104 is currently facing.

Once the VPS 136 has geo-localized the client device 104 and determined the corresponding portions/elements of the 3D model, the map/navigation application 132 can use the elements of the 3D model to augment the real-world view presented on (or otherwise visible through) the display 124. This augmentation includes annotating one or more objects within the view (e.g., indicating a direction to a destination point, labeling a level-change way point, etc.) or providing an indication of a direction to a level-change way point by, for example, presenting an off screen indicator on an edge of a real-world view corresponding to the direction. Annotations of objects in the view of the real world provided on (or otherwise visible through) the display 124 can assist the user in navigating through his or her environment. Moreover, in some implementations, the map/navigation application 132 may augment the real-world view with other information, such as the current time and/or date, the indoor space in which the user is currently located, and so on.

In the system 100, annotation is performed in full, or in part, by the annotation unit 138, after the VPS 136 has associated the various portions of the user's real-world view (as detected by one or more cameras of the sensors 130) with corresponding portions (including stores, level-change way points, etc.) of the 3D model of the environment. The annotation unit 138 annotates mapped elements, currently within the real-world view presented on (or otherwise visible through) the display 124, according to one or more algorithms that help the user to properly identify the mapped elements that he or she can see nearby.

FIG. 2B depicts an example navigation system interface 220 that may be presented by the map/navigation application 132 of the client device 104 showing a real-world 3D view of another portion of the indoor space of FIG. 2B. The navigation system interface 220 includes an example indication 221 representing directions to a destination point, and an example second indication 222 representing an escalator as a recommended or suggested level-change way point that may be used to reach the destination point. In the example of FIG. 2B, the first indication 221 indicates that CoffeeJoe, which is an example destination point, requires going down one or more floors or levels to floor 1, and the second indication 222 is an off screen indicator that includes an arrow portion 223 that points to the right at the right side of the navigation system interface 220 to indicate that a user needs to turn or move to the right to see or navigate towards the escalator as the recommended level-change way point. While an example off screen indication 222 is shown in FIG. 2B, the off screen indication 222 may have other forms. For example, not indicate the type of level-change way point.

FIG. 2C depicts an example navigation system interface 230 that may be presented by the map/navigation application 132 of the client device 104 showing a 2D or map view of a portion of the indoor space of FIGS. 2A and 2B. In some implementations, a user may enter the 2D or map view of FIG. 2C from the 3D view of FIG. 2B by, for example, pointing their camera downward toward the ground or floor. The navigation system interface 230 includes an example indication 231 representing the location of the user. The indication 231 includes an arrow 232 or other indicator that represents the direction the user is facing. The navigation system interface 230 further includes, like FIG. 2B, the indication 221 to indicate that CoffeeJoe, which is the destination point, is straight ahead but down one or more floors or levels to floor 1. The navigation system interface 230 also shows the indication 222 for the escalator as a recommended level-change way point that is to the left, and an indication 233 for an elevator as another level-change way point that is to the right. In the illustrated example of FIG. 2C, the indication 222 for the escalator is highlighted relative to the indication 233 for the elevator to indicate that the escalator is the recommended or suggested level-change way point selected by the map/navigation engine 146 and/or the map/navigation application 132.

In one implementation, the map/navigation engine 146 and/or the map/navigation application 132 selects a recommended or suggest level-change way point (e.g., the escalator) by identifying one or more level-change way points that are accessible from or service a starting level associated with a starting point. That is, identifying level-change way points that are accessible from or service the level of the indoor space that the user is currently on. For example, the map/navigation engine 146 and/or the map/navigation application 132 may identify level-change way points that have a point of access on the starting level. Example points of access include a landing of a staircase or escalator, and an elevator door.

However, some of the identified level-change way points may not, directly or indirectly, provide access to or service a destination level associated with a destination point. That is, in the examples of FIGS. 2A-2H, not all of the identified level-change way points may provide direct or indirect access to floor 1 on which CoffeeJoe is located. A level-change way point may provide indirect access by providing direct access to an intermediate level, where an additional level-change way point provides direct or indirect access to the destination level from the intermediate level. Accordingly, the map/navigation engine 146 and/or the map/navigation application 132 identifies a subset of the identified level-change way points that directly or indirectly provide access to or service the destination level.

In some examples, metadata associated with level-change way points is used to identify level-change way points that directly or indirectly serve or provide access to a starting level and a destination level, and/or, as described below, to select a recommended or suggested level-change way point from a list of level-change way points. Example metadata for a level-change way point includes coordinates for the level-change way point, coordinates for access points associated with the level-change way point, a list of levels directly served by the level-change way point, an indication of level-change way point type (e.g., stairs, ramp, elevator, escalator, etc.), indications of accessibility (e.g., wheelchair accessible, walker accessible, etc.), etc. In some examples, metadata for a level-change way point includes information representing past usage of the level-change way point. For example, how popular a level-change way point is (e.g., how it often used, how users rate the level-change way point, etc.), typical time delays associated with use of the level-change way point, whether the level-change way point is currently in service, etc.

The map/navigation engine 146 and/or the map/navigation application 132 may then apply one or more criteria to select one of the subset of the identified level-change way points as a recommended or suggested level-change way point. For example, the map/navigation engine 146 and/or the map/navigation application 132 may rank, sort, weight, or otherwise rate the subset of the identified level-change way points by applying the one or more criteria based upon metadata associated with the level-change way points, and selects the highest ranked or rated level-change way point as a suggested or recommended level-change way point.

A user may provide, select or otherwise input criteria by, for example, accessing a settings user interface of the user's navigation system interface. Additionally and/or alternatively, a system for selecting and presenting level-change way points for indoor navigation systems may learn or adapt criteria over time based upon recorded past usage of level-change way points by the user or other persons. For example, which level-change way points were most used in the past, which level-change way point was used to move from a particular starting point or nearby point to a particular destination point or nearby point, etc. In some examples, as a system learns or adapts criteria over time, the system may via the user's navigation system interface prompt a user to confirm a user preference. For example, the system may learn that the user appears to very frequently use escalators and, thus, may prompt the user to confirm their preference for escalators over other types of level-change way points.

In some examples, if one of the criteria indicates that a user requires an elevator or escalator, then the map/navigation engine 146 and/or the map/navigation application 132 may preclude from consideration other types of level-change way points, such as stairs and ramps, e.g., as reflected in their metadata.

In some examples, if one of the criteria indicates that a user requires wheelchair or walker accessibility, then the map/navigation engine 146 and/or the map/navigation application 132 may preclude from consideration level-change way points that do not accommodate walker or wheelchairs, for example, as reflected in their metadata.

In some examples, if one of the criteria indicates that a user cannot navigate steps or ramps, then the map/navigation engine 146 and/or the map/navigation application 132 may preclude from consideration stairs and ramps, for example, as reflected in their metadata.

In some examples, if one of the criteria indicates that a user prefers or has often used a closest level-change way point, then the map/navigation engine 146 and/or the map/navigation application 132 may select the recommended or suggested level-change way point to be the closest level-change way point based on coordinates for the level-change way points or their access points (e.g., as reflected in their metadata), and the location of a user.

In some examples, if one of the criteria indicates that a user prefers the fastest level-change way point, then, the map/navigation engine 146 and/or the map/navigation application 132 may select the level-change way point based on past typical delays associated with the level-change way points as, for example, reflected in their metadata.

In some examples, the map/navigation engine 146 and/or the map/navigation application 132 may select the level-change way point that the user used the last time they moved from the starting point or a nearby point to the destination point or a nearby point.

In some examples, if one of the criteria indicates that a user prefers the most popular level-change way point, then the map/navigation engine 146 and/or the map/navigation application 132 may select the recommended or suggested level-change way point based on recorded past usage data, way point ratings, usage trends, etc. for the level-change way points.

In some examples, the map/navigation engine 146 and/or the map/navigation application 132 may select the recommended or suggested level-change way point based on how congested the level-change way points currently are based upon the locations of persons in the indoor space. For example, if a large number of persons are currently waiting to use an elevator, then a different level-change way point may be selected subject to the user's abilities and/or preferences regarding other types of level-change way points. For example, they may be directed to an elevator despite the numbers of waiting persons because they require wheelchair accessibility.

In some examples, users may (e.g., via their navigation system interface) provide feedback regarding level-change way points. For example, they may provide ratings for level-change way points that the map/navigation engine 146 and/or the map/navigation application 132 may use in subsequent level-change way point selections to rank, sort, weight, or otherwise rate level-change way points.

The map/navigation engine 146 and/or the map/navigation application 132 provides directions to present the recommended or suggested level-change way point and/or navigation directions thereto in a user's navigation system interface of the client device 104, for example, as shown in the navigation system interfaces of FIGS. 2A-2H.

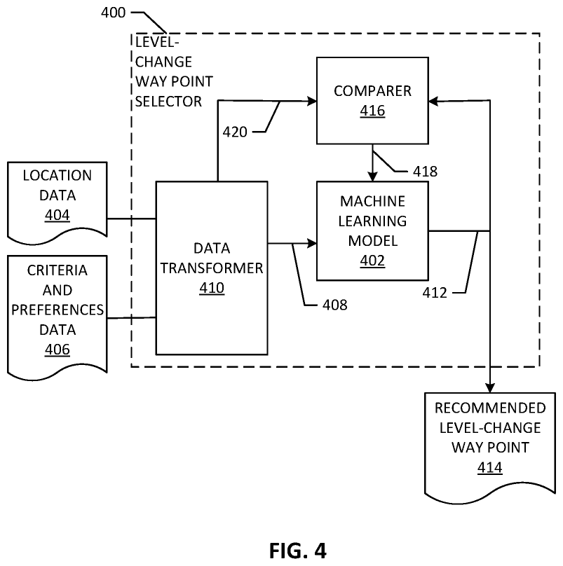

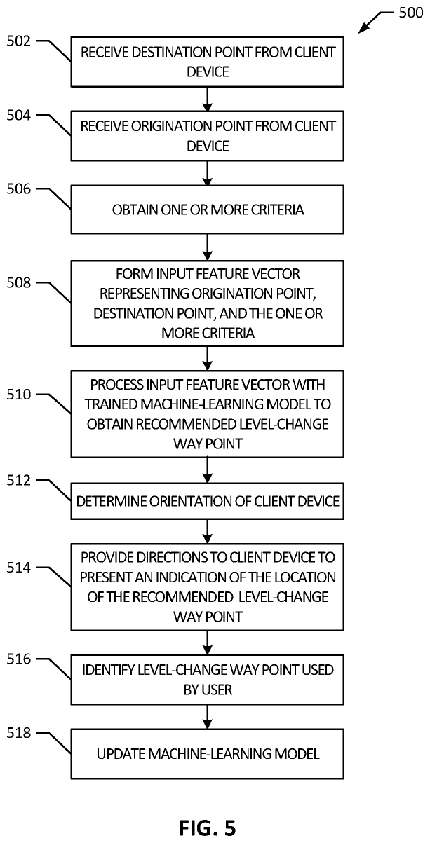

As discussed in more detail below in connection with FIGS. 4 and 5, the map/navigation engine 146 and/or the map/navigation application 132 may use a machine learning model to select a recommended or suggest level-change way points.

FIGS. 2D and 2E depict example navigation system interfaces 240 and 250, respectively, that may be presented by the map/navigation application 132 of the client device 104 as the user navigates or moves towards CoffeeJoe. In the example of FIG. 2D, the indication 222 for the escalator is shown generally in the middle of the navigation system interface 240 to signify that the escalator is generally straight ahead relative to the direction the user is facing, and the indication 221 is an off screen indicator shown on the right side of the navigation system interface 240 with an arrow 241 to indicate that the user needs to turn or move to the right to see or navigate towards CoffeeJoe.

In the example of FIG. 2E, the indication 222 is again shown generally in the middle of the navigation system interface 250 to signify that the escalator is generally straight ahead relative to the direction the user is facing. In FIG. 2E, the indication 221 is still an off screen indicator but is now shown on the left side of the navigation system interface 250 because the user has changed the direction they are facing, and the arrow 241 now indicates that the user needs to turn or move to the left to see or navigate towards CoffeeJoe.

FIG. 2F depicts an example navigation system interface 260 that that may be presented by the map/navigation application 132 of the client device 104 as the user reaches the bottom of the escalator. Because the user has reached the bottom of the escalator, the indication 222 for the escalator is no longer shown in the navigation system interface 260 of FIG. 2F. The indication 221 is an off screen indicator shown on the left side of the navigation system interface 260 with the arrow 241 indicating that the user needs to turn or move to the left to see or navigate towards CoffeeJoe.

FIG. 2G depicts an example navigation system interface 270 that that may be presented by the map/navigation application 132 of the client device 104 as the user turns left from the direction of FIG. 2F. The indication 221 for CoffeeJoe is now presented generally in the middle of the navigation system interface 260 to signify that CoffeeJoe is generally straight ahead relative to the direction the user is facing.

FIG. 2H depicts an example navigation system interface 280 that may be presented by the map/navigation application 132 of the client device 104 showing a 2D or floorplan view of a portion of the indoor space of FIGS. 2A and 2B (e.g., the first floor of the indoor space). In some implementations, a user may select a destination point (e.g., CoffeeJoe) by tapping or selecting an area 281 of the navigation system interface 280 corresponding to the destination point on a touchscreen of the client device 104 (e.g., the display 124).

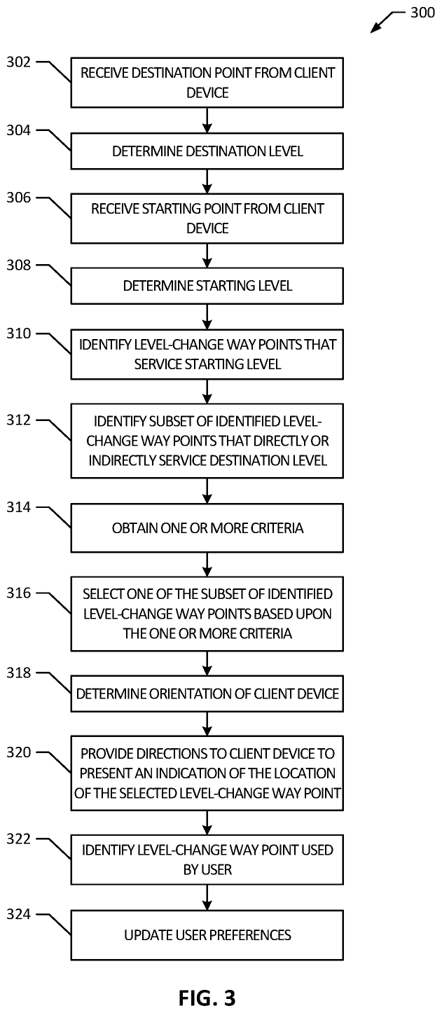

FIG. 3 is a flow diagram 300 of an example method that may be implemented by the map/navigation engine 146 and/or the map/navigation application 132 of FIG. 1 for selecting a level-change way point for recommendation, according to an implementation. While the flow diagram 300 is from the perspective of the map/navigation engine 146, the flow diagram 300 may, additionally and/or alternatively, be executed, in whole or in part, by the map/navigation application 132.

The method of FIG. 3 may be implemented as instructions stored on one or more machine-readable media and executed on one or more processors in one or more computing devices. For example, the method of FIG. 3 may be implemented by the processing unit 120 of the client device 104, when executing instructions of the map/navigation application 132, and/or by the processing unit 140 of the server 102, when executing instructions of the map/navigation engine 146. Additionally and/or alternatively, any or all of the blocks of FIG. 3 may be implemented by one or more hardware circuits structured to perform the corresponding operation(s) without executing software or instructions.

The flow diagram 300 starts at block 302 where an indication of a destination point is received from a client device 104. The client device 104 may determine the destination point using, for example, the navigation system interface 280 of FIG. 2H. A destination level associated with the destination point is determined at block 304. An indication of a starting point is received from the client device 104 at block 306. At block 308, a starting level associated with the starting point is determined.

The map/navigation engine 146 identifies one or more level-change way points that provide access from or service the starting level determined at block 308 (block 310). At block 312, the map/navigation engine 146 identifies a subset of the level-change way points identified at block 312 that, directly or indirectly, provide access to or service the destination level.

The map/navigation engine 146 obtains one or more criteria at block 314. In some implementations, one or more of the criteria and/or preferences are user defined. Additionally and/or alternatively, one or more of the criteria and/or preferences are learned for a user based on the level-change way points they use. As described above in connection with FIGS. 1, and 2A-2H, the map/navigation engine 146, at block 316, selects one of the subset of level-change way points based upon the one or more criteria.

Based on a determined orientation of the client at block 318, the map/navigation engine 146 provides directions to the map/navigation application 132 of the client device 104 for presenting an indication of the selected recommended or suggested level-change way point (block 320).

In some implementations, the map/navigation engine 146 identifies level-change usage data (e.g., the level-change way point used by the user, time it took to change levels, etc.) (block 322), and updates one or more of the criteria and/or user preferences based upon the level-change usage data (block 324).

FIG. 4 is a block diagram of an example level-change way point selector 400 that may be used by the map/navigation application 132 and/or the map/navigation engine 146 of FIG. 1 for selecting a recommended or suggested level-change way point. The level-change way point selector 400 includes an example machine learning model 402 to select a recommended or suggested level-change way point based on location data 404 and one or more criteria and/or user preferences 406. In some implementations, the machine learning model 402 is trained for recommending level-change way points for a particular indoor space. Alternatively, the machine learning model 402 may be trained for use with multiple indoor spaces.

The machine learning model 402 may be implemented by a set of computer-executable instructions that, when executed by one or more processors, implement a neural network, a convolutional neural network, an artificial neural network, etc. The machine learning model 402 may be trained, updated, etc. using supervised and/or unsupervised learning using, for example, a statistical model such as an XG gradient boosting model, a multinomial logistic regression model, a decision tree, a random forest model, a logistic regression model, etc. In general, training a machine learning model (e.g., the machine learning model 402) may include establishing a network architecture or topology, adding layers including activation functions for each layer, loss function, and optimizer. In an implementation, the machine learning model may use different activation functions at each layer, or between hidden layers and the output layer.

The level-change way point selector 400 includes an example data transformer 410 to form input feature vectors 408 for the machine learning model 402. The data transformer 410 forms the input feature vectors 408 based upon the location data 404 and the criteria and preferences data 406. An example input feature vector 408 includes encoded machine data representing a starting point, a destination point, and one or more criteria and preferences. The input feature vector 408 for the machine learning model 402 may be encoded in an N-dimensional tensor, array, matrix and/or other suitable data structure. When the machine learning model 402 is used to recommend level-change way points for multiple indoor spaces, an input feature vector 408 may include an identifier that represents a particular indoor space. In use, one or more outputs 412 of the machine learning model 402 are generated, in response to a particular input feature vector 408, that represent a recommended level-change way point 414 for use in reaching a particular destination point from a particular starting point as encoded in the input feature vector 408.

The level-change way point selector 400 includes an example comparer 416 to train the machine learning model 402. When the machine learning model 402 is being trained, the data transformer 410 forms a plurality of input feature vectors 408 for various combinations of starting point, destination point, and criteria (e.g., user provided, learned, etc.). The machine learning model 402 processes each input feature vector 408 to determine a recommended level-change way point 414. The comparer 416 determines (e.g., computes) differences 418 between known recorded known level-change way point usage data 420 and recommended level-change way points 414. For example, the differences 418 may represent that a first level-change way point 414 was recommended but a different level-change way point was actually used. The machine learning model 402 may be updated based upon the differences 418 using, for example, a statistical model such as an XG gradient boosting model, a multinomial logistic regression model, a decision tree, a random forest model, a logistic regression model, etc.

In some implementations, the machine learning model 402 is trained with a first portion of the data 404 and 406 (i.e., training data) associated with past recorded usage 420 of level-change way points for an indoor space (i.e., labeled training data). In some implementations, the machine learning model 402 is trained more than once with the first portion of the data 404 and 406. To verify the machine learning model 402, another portion of the data 404 and 406 also associated with recorded past usage 420 of level-change points (i.e., validation data) may be processed by the machine learning model 402 and a statistical metric of the errors 418 may be computed and used to determine when the performance of the machine learning model 402 is no longer improving through further training. In general, the process of training the machine learning model 402 causes weights, or parameters of the machine learning model 402 to be created. The weights may be initialized to random values. The weights may be adjusted as the machine learning model 402 is successively trained using one of several gradient descent algorithms to cause the values 412 output by the machine learning model 402 to converge to the expected or known (i.e., labeled) usage data 420.

In some implementations, the comparer 416 compares a recommended level-change way point 414 with an actual level-change way point usage in response to the recommendation as a difference 418 that can be used to update, adapt or otherwise further train the machine learning model 402 such that the quality of the recommended level-change way points 414 improves over time.

The machine learning model 402, the data transformer 410, the comparer 416 and/or, more generally, the level-change way point selector 400 of FIG. 4 may be implemented by hardware, software, firmware and/or any combination of hardware, software and/or firmware. Thus, for example, any of the machine learning model 402, the data transformer 410, the comparer 416 and/or, more generally, the level-change way point selector 400 could be implemented as instructions stored on one or more machine-readable media and executed by one or more programmable processors and/or servers of one or more local computing systems and/or one or more cloud computing systems.

FIG. 5 is a flow diagram 500 of an example method that may be implemented by the map/navigation engine 146 and/or the map/navigation application 132 of FIG. 1 for using the level-change way point selector 400 of FIG. 4 for selecting a level-change way point for recommendation, according to an implementation. While the flow diagram 500 is from the perspective of the map/navigation engine 146, the flow diagram 500 may, additionally and/or alternatively, be executed, in whole or in part, by the map/navigation application 132.

The method of FIG. 5 may be implemented as instructions stored on one or more machine-readable media and executed on one or more processors in one or more computing devices. For example, the method of FIG. 5 may be implemented by the processing unit 120 of the client device 104, when executing instructions of the map/navigation application 132. and/or by the processing unit 140 of the server 102, when executing instructions of the map/navigation engine 146. Additionally and/or alternatively, any or all of the blocks of FIG. 5 may be implemented by one or more hardware circuits structured to perform the corresponding operation(s) without executing software or instructions.

The flow diagram 500 starts at block 502 where an indication of a destination point is received from a client device 104. The client device 104 may determine the destination point using, for example, the navigation system interface 280 of FIG. 2H. An indication of a starting point is received from the client device 104 at block 504.

The map/navigation engine 146 obtains one or more criteria at block 506. In some implementations, one or more of the obtained criteria are user defined. Additionally and/or alternatively, one or more of the criteria are learned for a user or a plurality of users based on the level-change way points they use.

An input feature vector 408 for a machine learning model 402 is formed at block 508 that represents the destination point, the starting point and the one of more criteria. The machine learning model 402 processes the input feature vector 408 to generate a recommended level-change way point 414, at block 510.

Based on a determined orientation of the client at block 512, the map/navigation engine 146 provides directions for presenting an indication of the selected recommended or suggested level-change way point in a navigation system interface (block 514).

In some implementations, the map/navigation engine 146 identifies level-change usage data (e.g., the level-change way point used by the user, time it took to change levels, etc.) (block 516), and updates the machine learning model 402 based on difference therebetween (block 518).

Although the foregoing Detailed Description sets forth a detailed description of numerous different aspects, examples, and implementations of the disclosure, it should be understood that the scope of the patent is defined by the words of the claims set forth at the end of this patent. The Detailed Description is to be construed as exemplary only and does not describe every possible implementation because describing every possible implementation would be impractical, if not impossible. In the foregoing Detailed Description, it can be seen that various features are grouped together in various implementations for the purpose of streamlining the disclosure. This method of disclosure is not to be interpreted as reflecting an intention that the claims require more features than are expressly recited in each claim. Rather, as the following claims reflect, inventive subject matter may lie in less than all features of a single disclosed implementation. Thus, the following claims are hereby incorporated into the Detailed Description, with each claim standing on its own as a separately claimed subject matter. Numerous alternative implementations could be implemented, using either current technology or technology developed after the filing date of this patent, which would still fall within the scope of the claims. The disclosure herein contemplates at least the following examples:

Throughout this disclosure, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example implementations may be implemented as a combined structure or component. Similarly, structures and functionality presented as a single component may be implemented as separate components. For example, a process, method, article, or apparatus that comprises a list of elements is not necessarily limited to only those elements but may include other elements not expressly listed or inherent to such process, method, article, or apparatus. These and other variations, modifications, additions, and improvements fall within the scope of the subject matter of the present disclosure.

Unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

The term “coupled” as used herein is defined as connected, although not necessarily directly and not necessarily mechanically. A device or structure that is “configured” in a certain way is configured in at least that way, but may also be configured in ways that are not listed.

Unless specifically stated otherwise, discussions in the disclosure using words such as “processing,” “computing,” “calculating,” “determining,” “presenting,” “displaying,” “selecting,” “identifying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, each of the terms “tangible machine-readable medium,” “non-transitory machine-readable medium,” “machine-readable medium” or variants thereof is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium,” “machine-readable medium” or variants thereof is expressly defined to exclude propagating signals. That is, as used in any claim of this patent, none of the terms “tangible machine-readable medium,” “non-transitory machine-readable medium,” “machine-readable medium” or variants thereof can be read to be implemented by a propagating signal.

As used in the disclosure, the terms “substantially,” “essentially,” “approximately,” “about,” “generally” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%.

As used in the disclosure, any reference to “one implementation,” “an implementation,” “one aspect,” “an aspect,” etc. means that a particular element, feature, structure, or characteristic described in connection with the implementation, example, etc. is included in at least one implementation, example, etc. The appearances of the phrases “in one implementation,” “in some implementations,” “one aspect,” “an aspect,” etc. in various places in the specification are not necessarily all referring to the same implementation(s).

The Abstract is provided to allow the reader to quickly ascertain the nature of the technical disclosure. It is submitted with the understanding that it will not be used to interpret or limit the scope or meaning of the claims.

Upon reading this disclosure, those of skill in the art will appreciate still additional alternative structural and functional designs for facilitating indoor navigation through the disclosed principles in the present disclosure. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

1. A method for selecting and presenting level-change way points for indoor navigation systems, the method comprising:
receiving, from a client device having a navigation system interface, a request for navigation directions from a starting point to a destination point;
identifying, by one or more processors, a plurality of level-change way points based on a starting level associated with the starting point;
determining, by one or more processors, a subset of two or more of the plurality of level-change way points based on a destination level associated with the destination point;
selecting, by one or more processors, a selected level-change way point from the subset based upon one or more criteria; and
providing, to the client device, directions to present an indication of a location of the selected level-change way point in the navigation system user interface.

2. The method of claim 1, wherein determining the subset based on the destination level includes:
determining, for each of the plurality of level-change way points, a plurality of levels served by the level-change way point; and
determining, for each of the plurality of level-change way points, to include the level-change way point in the subset when its plurality of levels includes the destination level.

3. The method of claim 2, wherein determining, for each of the plurality of level-change way points, the plurality of levels served by the level-change way point is based on metadata for the level-change way point that defines the levels served by the level-change way point.

4. The method of claim 1, wherein determining the subset based on the destination level includes:
determining, for a first level-change way point of the plurality of level-change way points, a second level-change way point that serves at least one level that is also served by the first level-change way point; and
determining to include the first level-change way point in the subset when the second level-change way point serves the destination level.

5. The method of claim 1, wherein selecting the selected level-change way point from the subset based upon the one or more criteria includes determining which of the two or more of the plurality of level-change way points of the subset satisfy a user-defined preference.

6. The method of claim 1, wherein selecting the selected level-change way point from the subset based upon the one or more criteria includes determining which of the two or more of the plurality of level-change way points of the subset represents a fastest path between the starting point and the destination point.

7. The method of claim 1, wherein selecting the selected level-change way point from the subset based upon the one or more criteria includes determining which of the two or more of the plurality of level-change way points of the subset represents a most popular path between the origin and the destination.

8. The method of claim 1, wherein selecting the selected level-change way point from the subset based upon the one or more criteria includes applying a machine learning algorithm.

9. The method of claim 1, wherein the indication includes a symbol representative of a type of the selected level-change way point.

10. The method of claim 1, wherein the indication includes an off screen indicator representative of the selected level-change way point being located beyond a boundary of the navigation system user interface.

11. The method of claim 1, wherein the directions include a set of navigation directions from the starting point to the destination point.

12. The method of claim 1, wherein identifying the plurality of level-change way points based on the starting level includes identifying all level-change way points that serve the starting level.

13. The method of claim 1, wherein the navigation system user interface includes an augmented reality view that includes a first indication of a location of the recommended or suggested level-change way point alongside a real-time image or video of an indoor space.

14. The method of claim 13, wherein the augmented reality view includes a second indication of a location of another level-change way point.

15. The method of claim 14, wherein the first indication represents a type of the recommended or suggested level-change way point, and the second indication represents a type of the another level-change way point.

16. The method of claim 1, wherein the one or more criteria do not include a criteria to select a closest level-change way point.

17. A computing device configured to implement the method of claim 1.

18. A system comprising:
one or more processors; and
non-transitory, machine-readable medium storing instructions that, when executed by the one or more processors, cause the to
receive, from a client device having a navigation system interface, a request for navigation directions from a starting point to a destination point;
identify a plurality of level-change way points based on a starting level associated with the starting point;
determine a subset of two or more of the plurality of level-change way points based on a destination level associated with the destination point;
select a selected level-change way point from the subset based upon one or more criteria; and
provide, to the client device, directions to present an indication of a location of the selected level-change way point in the navigation system user interface.

19. The system of claim 18, wherein to determine the subset based on the destination level, the instructions cause the system to:
determine, for each of the plurality of level-change way points, a plurality of levels served by the level-change way point; and
determine, for each of the plurality of level-change way points, to include the level-change way point in the subset when its plurality of levels includes the destination level.

20. The system of claim 19, wherein to determine, for each of the plurality of level-change way points, the plurality of levels served by the level-change way point, the instructions use metadata for the level-change way point that defines the levels served by the level-change way point.
